(19) United States
(12) Patent Application Publication
(10) Pub. No.: US 2009/0179805 A1
(43) Pub. Date: Jul. 16, 2009

(54) ANTENNA SYSTEM FOR WIRELESS DIGITAL DEVICES

(75) Inventors: IAIN ROY, Owen Sound (CA); LAURIAN PETRU CHIRILA, Irvine, CA (US)

Correspondence Address: PEARNE & GORDON LLP, 1801 EAST 9TH STREET, SUITE 1200, CLEVELAND, OH, 44114-3108, US

(73) Assignee: PSION TEKLOGIX INC., MISSISSAUGA (CA)

(21) Appl. No.: 12/256,033

(22) Filed: Oct. 22, 2008

Related U.S. Application Data
(60) Provisional application No. 60/982,035, filed on Oct. 23, 2007.

(51) Int. Cl. H01Q 21/29; H01Q 1/24; H01Q 1/48; H01Q 1/52

(52) U.S. Cl. 343/702; 343/893; 343/848; 343/841

(57) ABSTRACT

An antenna system for a wireless digital device is provided. The antenna system includes an array of N antennas (N: integer) housed within a wireless digital device, each of the n antennas covering an angular sector in space approximately equal to 2*π/N radians in azimuth. The antenna system includes a mounting structure for arranging the antennas in a wireless digital device to provide a pseudo-omnidirectional electromagnetic spatial coverage such that the total azimuthal coverage toward the exterior of the wireless digital device is substantially spherical except for the direction of a user using the wireless digital device, and the combined antenna radiation patterns exhibit a strong null in the direction of the user.

### FIELD OF INVENTION

The present invention relates to antenna technologies, more specifically to an antenna system for wireless digital devices.

### BACKGROUND OF THE INVENTION

It has been reported in the media and in the scientific literature that electronic systems that intentionally emit electromagnetic energy could potentially have certain biological effects upon their users. In the United States, the permissible levels of occupational and general population exposure to electromagnetic waves at radio frequencies are regulated by the Federal Communications Commission (FCC) through its Office of Engineering Technology (OET). OET bulletin 56 provides an introduction to the issues and guideline development, and OET Bulletin 65 provides methods for evaluating compliance to the FCC's guidelines. The exposure levels are determined for electronic intentionally-radiating equipment as an empirically-measured value referred to as Specific Absorption Rate (SAR). Other worldwide regulators have developed similar guidelines.

While such effects are not currently thought to produce any long-term detriment to human health, it would be reassuring to the user of such intentionally radiating electronic equipment to know that the level of radiation (SAR) in the direction of the user had been minimized. This is of particular value to users of cellular telephones, wireless Personal Digital Assistants (PDAs), combination digital/communication devices, portable rugged or semi-rugged data collection terminals, handheld two-way radios, and a plethora of other wireless bodyworn or handheld communication devices that intentionally emit radiation while in close proximity to the human body.

At the same time, those practiced in the art of development of such digital devices will appreciate that undesired electromagnetic signals may be emitted unintentionally by the various electronic systems internal to the devices. These signals may interfere to a greater or lesser degree with the desired signals produced and intended to be received by the wireless communications components of the devices. Thus, it would be advantageous to the developer of such devices to have access to a technological advance permitting the rejection of the unwanted electromagnetic signals, while simultaneously permitting the unfettered capture and emission of desired wireless communication signals.

At the same time, it is desirable for digital communication devices to be able to establish a communications link to a network access point, base station or other element of the communications infrastructure in any azimuthal direction. Omnidirectional coverage, as a highly desirable feature, might superficially be considered to be incompatible with the above-stated goal of reducing emissions in the single direction of the user of the device.

### SUMMARY OF THE INVENTION

It is an object of the invention to provide a method and system that obviates or mitigates at least one of the disadvantages of existing systems.

According to an aspect of the present invention there is provided an antenna system which includes an array of N antennas (N: integer). Each of the N antennas covers an angular sector in space approximately equal to 2*π/N radians in azimuth. The antenna system includes a mounting structure for mounting the array of N antenna in a wireless digital device to provide a pseudo-omnidirectional electromagnetic spatial coverage such that the total azimuthal coverage toward the exterior of the wireless digital device is substantially spherical except the direction of a user using the wireless digital device and the combined antenna radiation pattern exhibits a strong null in the direction of the user.

### BRIEF DESCRIPTION OF THE DRAWINGS

These and other features of the invention will become more apparent from the following description in which reference is made to the appended drawings wherein:

FIG. 1 is a perspective view illustrating an example of a handheld wireless digital device with an antenna system, in accordance with an embodiment of the present invention;

FIG. 2 is a top view of the wireless device of FIG. 1;

FIG. 3 is a cross section view illustrating an example of an antenna applied to the device of FIG. 1;

FIG. 4 is a top view of the antenna of FIG. 3;

FIG. 5 is a bottom view of the antenna of FIG. 3;

FIG. 6 is a diagram illustrating an example of a 2-D radiation pattern for an antenna in FIG. 1;

FIG. 7 is a diagram illustrating an example of a 3-D radiation pattern for the antenna in FIG. 1;

FIG. 8 is a diagram illustrating an example of a combined radiation pattern for antennas in FIG. 1;

FIG. 9 is a Voltage Standing Wave Ratio (VSWR) graph for the internal antenna in the device of FIG. 1;

FIG. 10 is a diagram illustrating a combination of the antennas and a receiving apparatus in the device of FIG. 1;

FIG. 11 is a diagram illustrating a combination of the antennas and a transmitting apparatus in the device of FIG. 1;

FIG. 12 is a perspective view illustrating an example of a handheld wireless device with an antenna system in accordance with another embodiment of the present invention;

FIG. 13 is a top view of the wireless device of FIG. 12;

FIG. 14 is a diagram illustrating an example of a combined radiation pattern for antennas in FIG. 12; and

FIG. 15 shows an example of a measured radiation pattern from an example of the handheld wireless digital device of FIG. 1.

### DETAILED DESCRIPTION

Embodiments of the present invention are described using handheld or portable wireless digital devices. Antenna systems according to the embodiments of the present invention provide a pseudo-omni-directional spatial coverage antenna pattern for desired electromagnetic communications in substantially all azimuthal directions except that occupied by the user of a handheld or portable wireless digital device, while simultaneously rejecting undesired electromagnetic signals emanating from the internal electronic subassemblies of the digital device in both the spatial and frequency domains.

The antenna systems according to the embodiments of the present invention are implemented with, for example, but not limited to, cellular telephones, PDAs, combination digital/communication devices, portable rugged or semi-rugged data collection terminals, handheld two-way radios, and a plethora of other wireless bodyworn or handheld communication devices that intentionally emit radiation while in close proximity to the human body. In the description, the terms “handheld” and “portable” may be used interchangeably. In the description, the terms “housing”, “casing” and “packaging” may be used interchangeably.

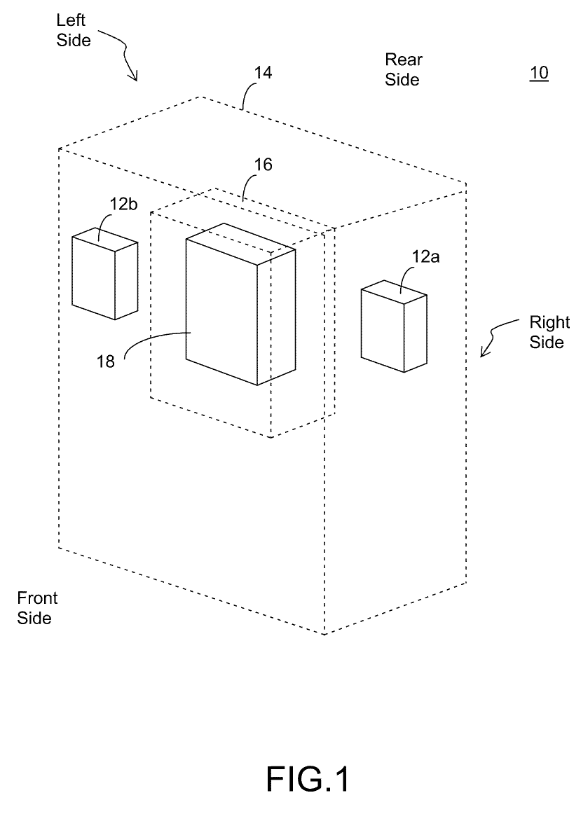

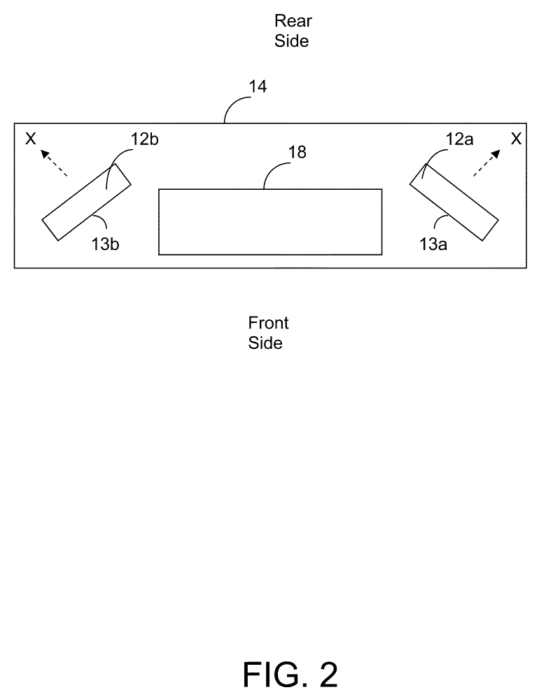

FIG. 1 is a perspective view illustrating an example of a handheld wireless digital device with an antenna system, in accordance with an embodiment of the present invention. FIG. 2 is a top view of the handheld wireless digital device of FIG. 1. The handheld wireless digital device 10 of FIGS. 1-2 includes a plurality of internal antennas (N: the number of antennas). In FIGS. 1-2, two antennas 12a and 12b are shown as an example of the plurality of antennas (N=2). The antennas 12a and 12b are, for example, fully planar slot antennas. As described below, each antenna 12a, 12b exhibits a radiation pattern that tends to be directional.

A user faces the front side of the handheld wireless digital device 10 when using the handheld wireless digital device 10. In the description below, “a (the) front side (of the handheld wireless digital device)” or “a (the) front face (of the handheld wireless digital device)” represents one side of a wireless device, which faces to a user when the user uses the handheld wireless digital device, and “a (the) rear side” represents a side opposite to the front side. For example, a display is placed in the front side. The antenna system having the antennas 12a and 12b for the handheld wireless digital device 10 exhibits high receiving efficiency in substantially all azimuthal directions except a sector blocked or occupied by presence of the user, as described below.

The handheld wireless digital device 10 includes one or more electronic subassemblies 16 internal to the handheld wireless digital device 10. The electronic subassemblies 16 include one or more electromagnetically reflective assemblies 18. The electromagnetically reflective assemblies 18 are, for example, but not limited to, a main electronic assembly, a mechanical frame assembly, a display assembly, or combinations thereof. The minimum requirements for an assembly to be electromagnetically reflective are that the assembly be highly conductive, e.g. comprised substantially of copper, tin, magnesium or any other similarly-conductive metal; and that the assembly be of physical dimensions greater than, for example, one-tenth of a wavelength at the lowest passband frequency of operation of any of the antennas producing intentionally-radiated communications signals from the device.

The antennas 12a and 12b are located within a housing 14 of the handheld wireless digital device 10. The antennas 12a and 12b are arranged at opposing locations within the confines of the device housing 14, behind the device walls. In FIGS. 1-2, the antennas 12a and 12b are located at the left and right sides of the device 10, between the electronic subassemblies 16 and the external walls.

The handheld wireless digital device 10 may be a rugged or semi-rugged device that can meet the requirements of harsh environments/harsh usage applications. The walls, frames, covering or housing of the device 10 may be formed to insert or surround the assemblies 16 and the antennas 12a and 12b. The system 10 may include one or more parts for holding at least one component of the device 10, e.g., assembly 16, antenna 12a, 12b, in a certain position. In another example, at least a part of the walls, frames, covering or housing of the device 10 may be integrated to at least one component, e.g., assembly 16, antenna 12a, 12b. For example, a printed circuit board forming any of the components of the device 10 may be integrated with at least a part of the walls, frames, covering or housing of the device 10. The handheld wireless digital device 10 may have a sealing that prevents the ingress of undesirable materials, e.g., water and dust. The handheld wireless digital device 10 may have a frame that is internal to the device 10 and prevents the undesirable materials from entering each electronics.

In one example, the handheld wireless digital device 10 has a mounting structure for mounting the antennas 12a and 12b into the device 10 so that the combined antenna pattern of the antennas 12 and 12b exhibits a strong null toward the front of the handheld wireless digital device 10. In another example, the mounting structure is provided for mounting the antennas 12a and 12b with respect to one or more assemblies 18 so that the combined antenna patter is modified by the presence of the one or more assemblies 18.

In one example, the mounting structure for the antennas 12a and 12b may be formed in or on the housing 14. In another example, the mounting structure for the antennas 12a and 12b may be integrated, molded or attached with the housing 14.

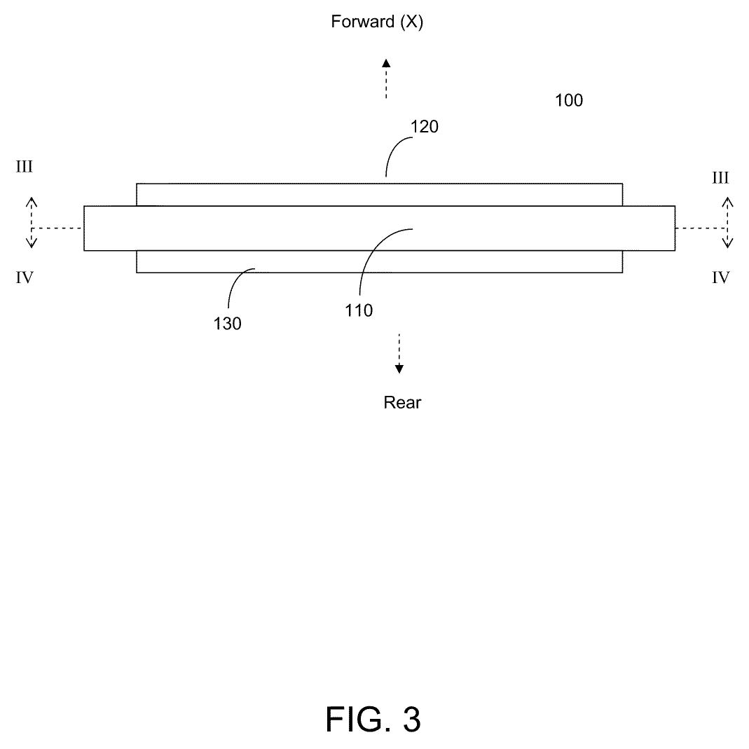

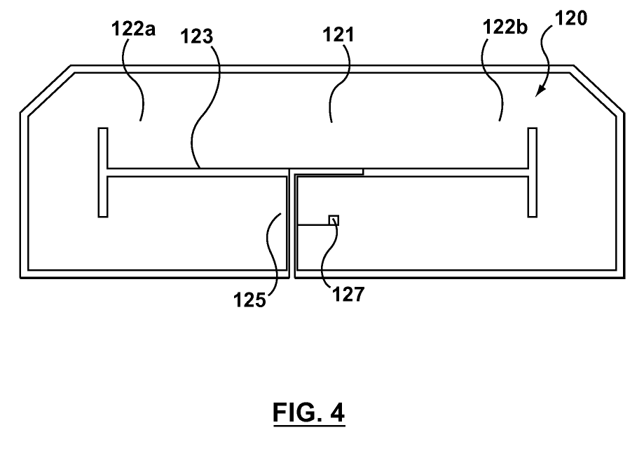

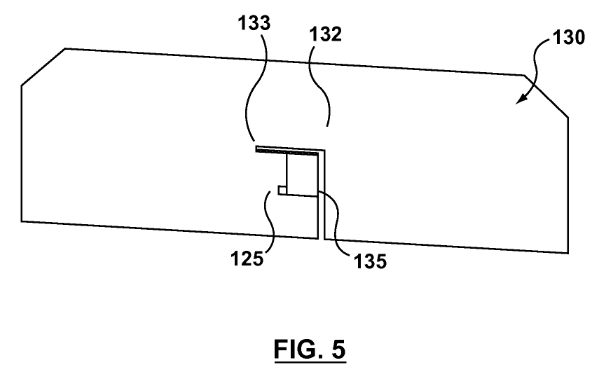

U.S. Pat. No. 7,050,009 provides one example of a set of antenna designs that meet the requirements for the constitution of the desired overall spatial radiation pattern. FIG. 3 is a cross section view illustrating an example of the antenna applied to the device 10 of FIG. 1. FIG. 4 is a top view of the antenna of FIG. 3. FIG. 5 is a bottom view of the antenna of FIG. 3. The detail of the antenna shown in FIGS. 3-5 is disclosed in U.S. Pat. No. 7,050, 009. The antenna structure disclosed in U.S. Pat. No. 7,050,009 is incorporated herewith by reference.

Referring to FIGS. 3-5, the antenna 100 includes a substrate 110 having two oppositely directed conductive planes 120 and 130. The plane 120 may be referred to as the source plane 120 while the bottom plane 130 may be referred to as the ground plane 130. Slots (e.g., 121, 132) are formed in the planes 120 and 130 respectively.

The substrate 110 may be, for example, the substrate portion of a printed circuit board (PCB). The conductive planes 120, 130 are created by covering the substrate 110, through lamination, roller-cladding or any other such process, with a layer of a conductive material, for example copper. The source plane conductor 120 is electrically isolated from the ground plane conductor 130. Source slot (e.g., 121) and ground slot (e.g., 132) are created by etching, or otherwise removing, conductive material from the conductive planes 120, 130 respectively.

The relative positioning and sizing of the slots on the source plane 120 and the ground plane 130 may be adjusted so as to enhance the radiation intensity in the forward direction (e.g., X of FIGS. 2-3) and reduce the radiation intensity in the rear direction (e.g., a side opposite to X of FIGS. 2-3). This may be accomplished by considering the relative phases of the radiation component from each plane. Similarly, the spacing between the planes may be adjusted to optimize the interaction of the radiation from each plane to attain the desired radiation pattern.

Each of the slots may extend from a peripheral edge of said substrate. At least one of the slots may be L shaped. Each of the slots may have an axial leg extending on a longitudinal axis of the antenna and a transverse leg extending from the peripheral edge to intersect the axial leg. The axial legs may be aligned on each of the planes 120 and 130. The transverse legs may be aligned on each of said planes. One of the slots may be formed as an H with an intermediate leg extending to a peripheral edge. The length of the slot in the source plane may be between 1.46 and 1.36 that of the slot in the ground plane 130. The length of the slot in the source plane 120 may be between 1.60 and 1.51 that of the slot in the ground plane 130. The length of the slot in the source plane 120 may be between 3.0 and 3.04 that of the slot in the ground plane 130.

As shown in FIGS. 4-5, each of the slots 121 and 132 may have one or more than one axial leg (e.g., 123, 133), extending parallel to the longitudinal axis of the antenna, and one or more than one traverse leg (e.g., 122a, 122b, 125, 135), extending normal or transverse to the axis. The legs are juxtaposed on each plane so that the legs are aligned with one another. In FIGS. 4-5, the slot 121 of the source plane 120 has a H-pattern having a single axial bar 123 terminating in a pair of traverse legs 122a and 122b. The axial bar 123 is connected to an intermediate leg 125 extending from the axial bar 123 to the periphery. The leg 125 is aligned with the traverse legs 122a and 122b of the slot 121. The slot 132 of the ground plane 130 has a L-pattern having an axial bar 133 terminating in the traverse leg 135. The leg 135 extends to the periphery. The leg 133 of the ground plane 130 is aligned with the axial bar 123 of the source place 120. A signal feed line (not shown) is connected to the source plane 120 at hole 127, and the ground plane 130 connected to ground, either by a cable shield or through a mechanical connector with the body of a device (e.g., 10 of FIG. 1). The slots are sized and positioned relative to one another to inhibit the intensity of radiation emanating from the ground plane 130.

In one example of a configuration, the axial length of the bar 123 is 1400 mill and each of the traverse legs are 415 mill. The intermediate leg 125 is 370 mill and is offset to be 600 mill from one of the legs 122a and 122b. The bar and/or leg of the slot 132 is 0.370 mill. The width of the slot is 0.020 mill. The overall dimensions of the antenna is, for example, about 1960×688 mill.

Alternatively, the substrate 110 may be another non-conductive material such as a silicon wafer or a rigid or flexible plastic material. The substrate 110 may also be formed into a non-flat shape e.g., curved, so has to fit into a specific space within, for example, the device body. Certain desirable properties such as increased efficiency may be obtained by using a material for the substrate 110 that has specific properties, such as a particular permittivity or dielectric constant, at the desired frequency or frequency range of operation. For example, at higher frequencies, such as a frequency of 5 GHz, a higher dielectric constant may be desirable. Preferably, the material used for the substrate 110 has uniform thickness and properties.

The antennas disclosed in U.S. Pat. No. 7,050,009 possess a high front-to-back ratio, defined as the ratio of the electromagnetic power radiated in the forward (desired beam) direction divided by the electromagnetic power unintentionally radiated in the rear (undesired reverse beam) direction. They are flat planar antennas that may be dispositioned within the host communications device housing appropriately as in FIGS. 1-2. They possess desirable qualities of high radiation efficiency and small size relative to the wavelength at the frequency of operation. They possess a radiation pattern exhibiting strong lateral radiation nulls and approximately hemispherical desired beamwidth. This beamwidth can be adjusted by design to cover the required angular sector equal to 2π/N radians in azimuth.

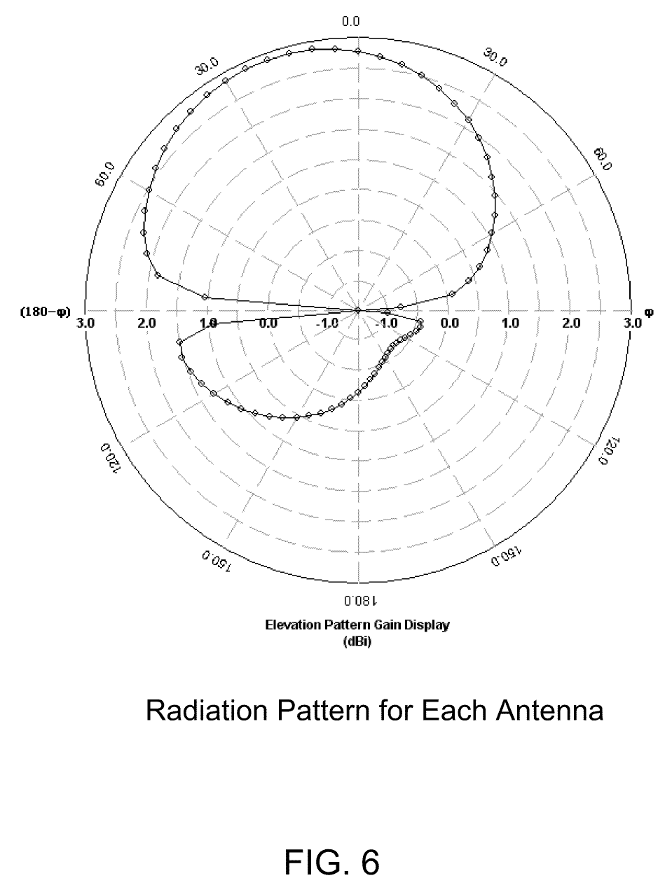

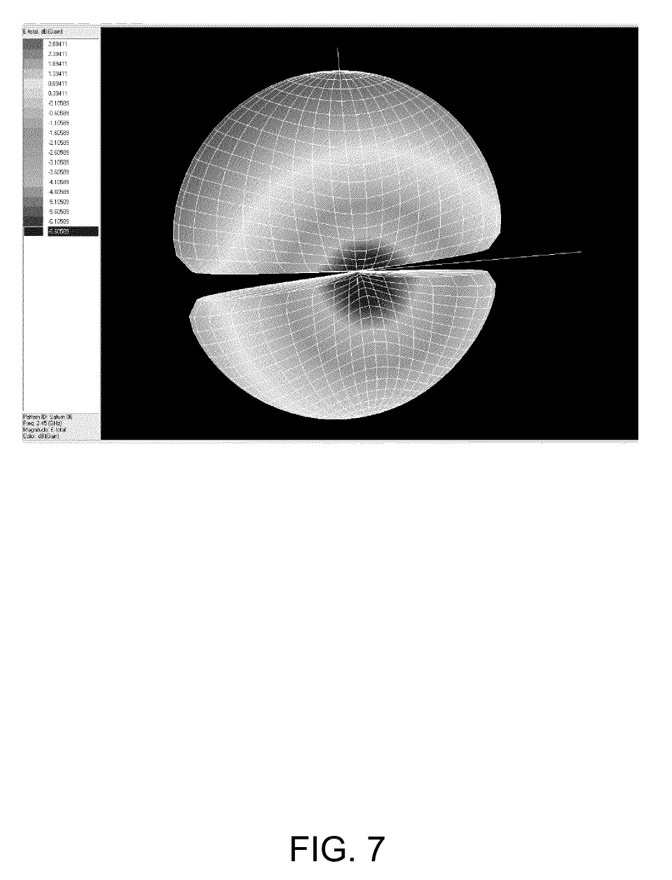

FIG. 6 is a sectional view of an example of a 2-D radiation pattern for each antenna 12a, 12b when using the antenna design of FIGS. 3-5. FIG. 7 is a sectional view of an example of a 3-D radiation pattern for each antenna 12a, 12b when using the antenna design of FIGS. 3-5. Each of the antennas covers an angular sector in space approximately equal to 2π/N radians in azimuth. The total azimuthal coverage toward the exterior of the device 10 is substantially spherical.

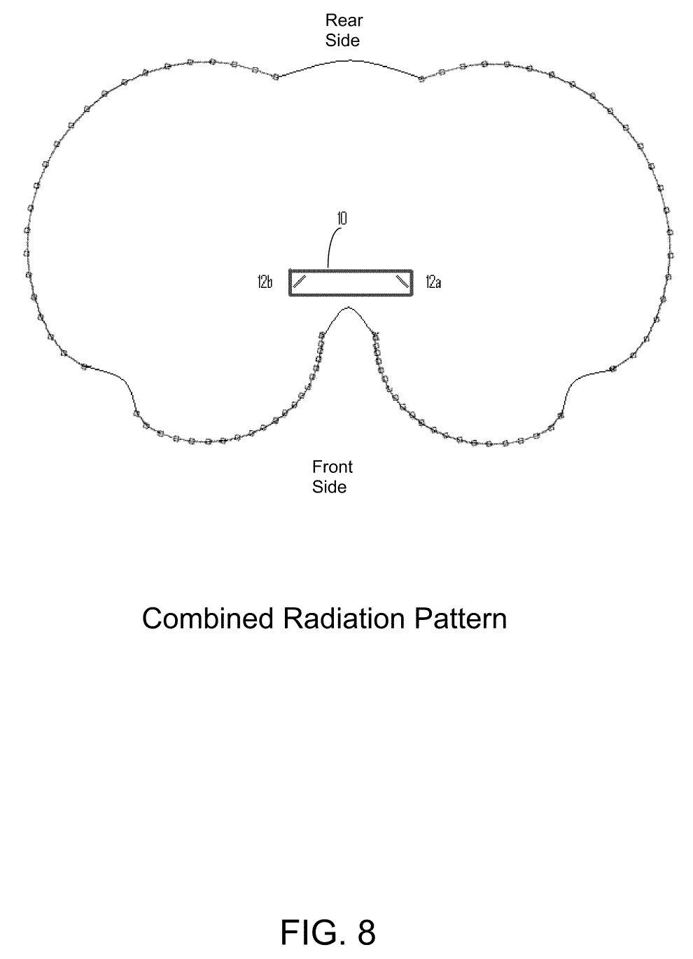

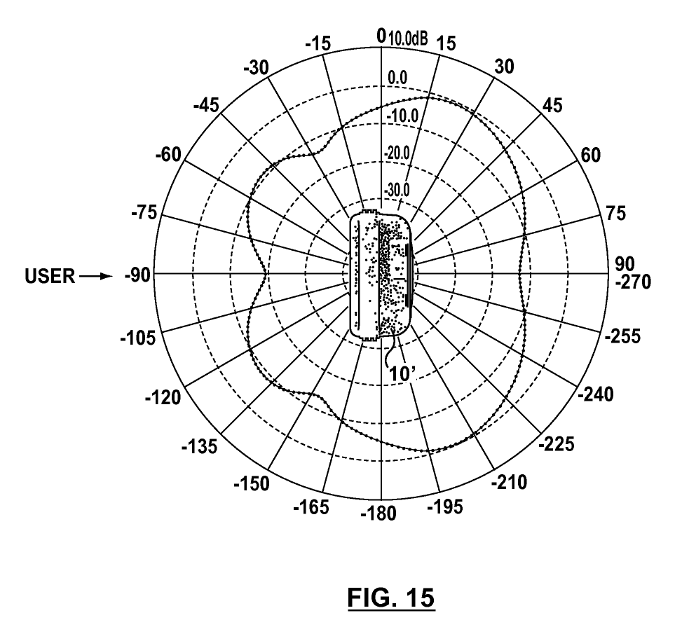

The combined antenna radiation patterns exhibit a strong null in the direction of the user of the device (front), as shown in FIG. 8. Specifically, the lateral radiation nulls of the individual antennas are exploited in combination to provide an engineered null in the desired direction. The combined antenna radiation in the front of the handheld wireless digital device 10 of FIG. 1 (i.e., the direction toward the user of the handheld wireless digital device 10) and the absorption (SAR) thereof by the user) is minimized. FIG. 15 shows an example of a measured radiation pattern from an example of the handheld wireless digital device 10 (10′ in FIG. 15). As shown in FIGS. 8 and 15, the radiation pattern from the handheld wireless digital device is directional so that the radiation pattern toward the user of the handheld wireless digital device is null (e.g., 19 dB below the peak). The energy radiated toward the user is, for example, less than 1%.

The combined antenna radiation patterns may optionally be modified by the presence of the electromagnetically reflective assemblies 18. Specifically, the electromagnetically reflective assemblies reflect any portion of radiation from the rear (e.g., ground plane 130 of FIG. 3) of the antennas, e.g., 13a and 13b of FIG. 2, and guide it toward the exterior of the communications device and away from the direction of the user. The user is thus further shielded from leakage radiation.

The radiation patterns of the antennas 12a and 12b of FIG. 1 exhibit positive gain in the forward direction, defined as the direction toward which the intentionally-radiating plane 120 of the antenna produces a strong hemispherical or sectoral beam. They exhibit negative gain (loss) in the reverse direction, defined as the opposite direction to the forward direction. When the forward beam is directed to the outside of the communications device and the reverse beam is directed towards its internal components, undesirable electromagnetic signals from inside the digital device 10 are effectively rejected, while desired signals from outside the digital device 10 are enhanced.

The antennas 12a and 12b possess frequency-dependent characteristics such that they reject electromagnetic signals whose frequencies do not fall within the desired passband of the antennas. The antennas are designed electrically and physically such that their passbands are substantially restricted to the desired frequency ranges of communication, allowing for a small additional percentage bandwidth to permit expected manufacturing variations to occur without detriment to the desired operation of the antennas. At substantially all other frequencies occurring within the communications device, the antennas are by design inefficient and effectively fail to pass undesired frequencies and signals.

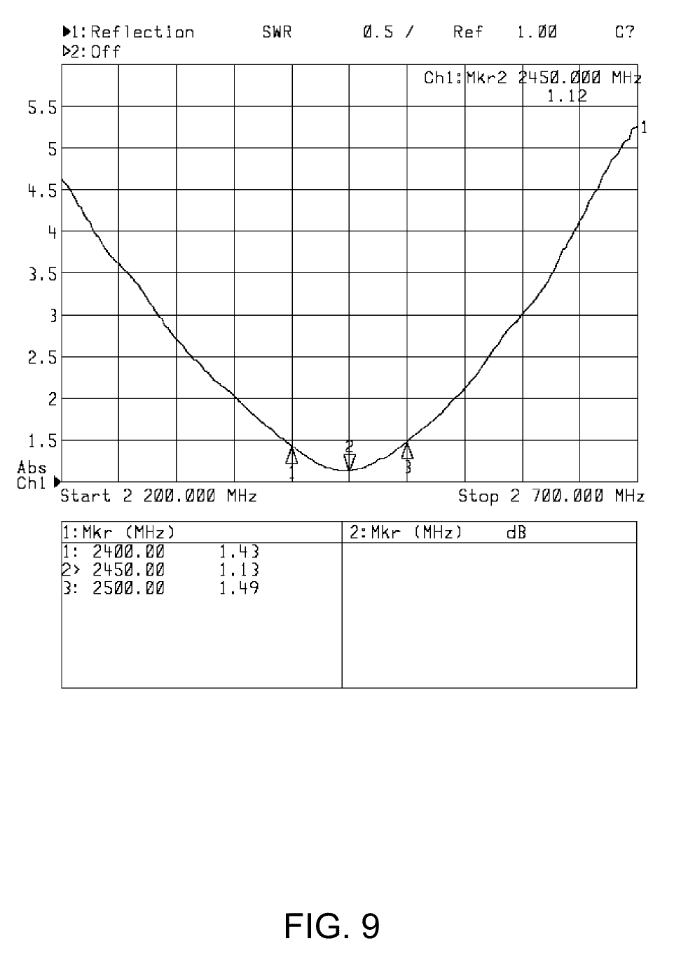

FIG. 9 is a Voltage Standing Wave Ratio (VSWR) graph for the internal antenna in the device 10 of FIG. 1. As well known by a person skilled in the art, VSWR is used as a performance parameter to quantify the percentage of power that will be reflected at the input of the antenna. When VSWR is evaluated, a value closer to 1.00:1 is more desirable than one that is higher. In FIG. 9, the antenna 100 of FIGS. 3-5 is used in the device 10 of FIG. 1. As shown in FIG. 9, the internal antenna displays very good VSWR measurement for the desired frequency range of 2.4 GHz to 2.5 GHz. Usually for an internal antenna the requirements are that VSWR values to be below 3. The antenna reads VSWR values below 1.5 (equivalent with an external antenna) but with a low profile, suitable to get inside of a portable terminal.

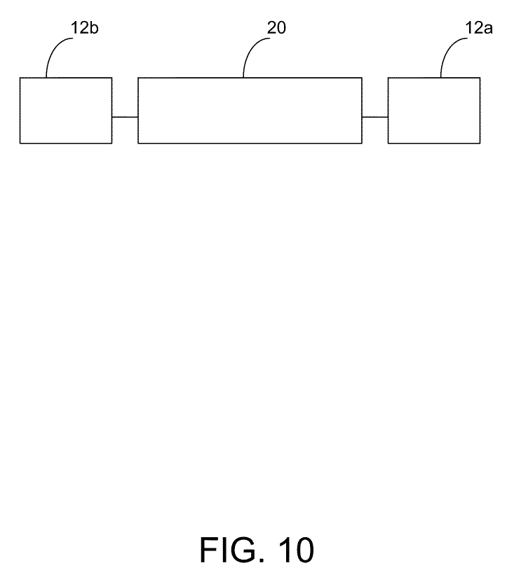

The handheld wireless digital device 10 of FIG. 1 may be a communication device having a functionality of receiving wireless signals via at least one of the antennas 12a and 12b. For example, the antennas 12a and 12b receive wireless signals. As shown in FIG. 10, the antennas 12a and 12b are coupled directly to a radio receiving apparatus 20 in the handheld wireless digital device 10, which is provided for receiving signals from the antennas 12a and 12b and may communicate with a processor for processing the received signals. The receiving apparatus 20 may optionally be capable of selecting the strongest signal from any one of the antennas 12a and 12b. The receiving apparatus 20 communicates with the electronic subassemblies 16.

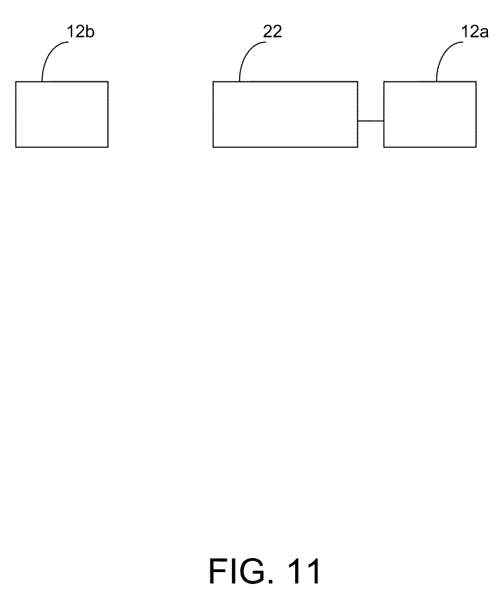

The handheld wireless digital device 10 of FIG. 1 may be a communication device having a functionality of transmitting wireless signals. For example, at least one of the antennas 12a and 12b transmits wireless signals. In one example, as shown in FIG. 11, the antenna 12a is coupled to a radio transmitting apparatus 22 in the handheld wireless digital device 10, which is provided for transmitting signals via the antennas 12a and 12b.

The antennas 12a and 12b of FIG. 1 may be multi-band antennas capable of transceiving electromagnetic signals in a plurality of passbands while rejecting electromagnetic signals whose frequencies do not fall within the desired passband of the antennas.

In FIGS. 1-2, two antennas are shown. However, the number of antennas, “N”, is not limited to two, and may vary and may be N>2. It will be understand by one of ordinary skill in the art that the configuration of the antennas and the device shown in FIG. 1 is one example, and is not limited to that of FIG. 1. The antennas in the wireless device 10 may be L-shaped planar antennas, or any of the implementations disclosed in U.S. Pat. No. 7,050,009, or any other antenna design meeting the guidelines for directivity, nulls, efficiency, small size and adjustable beamwidth above.

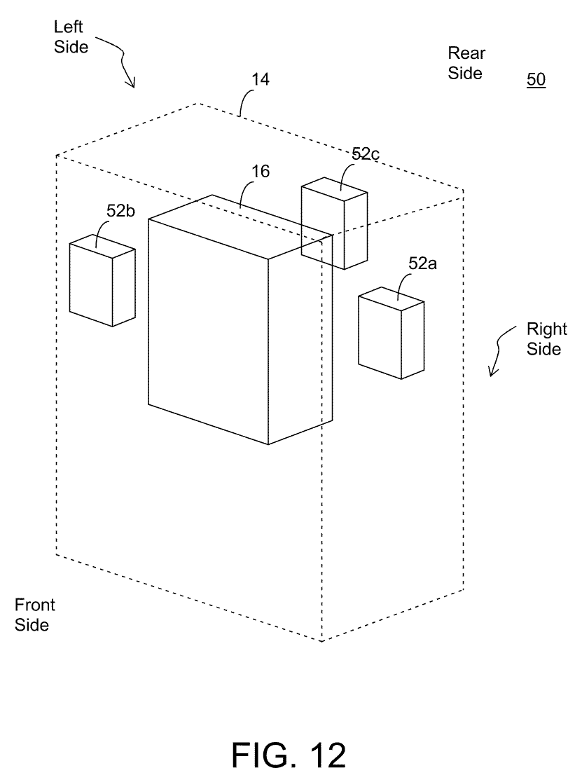

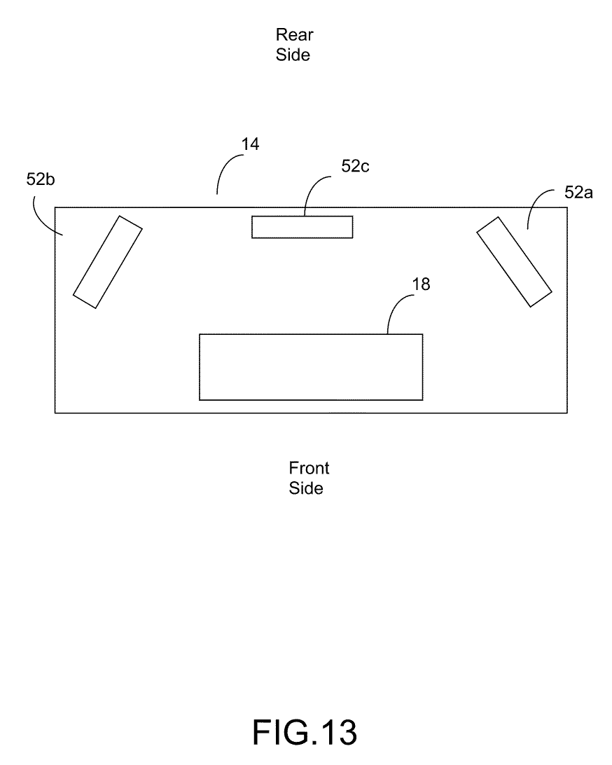

FIG. 12 is a perspective view illustrating an example of a handheld wireless digital device with an antenna system in accordance with another embodiment of the present invention. FIG. 13 is a top view of the handheld wireless digital device of FIG. 12.

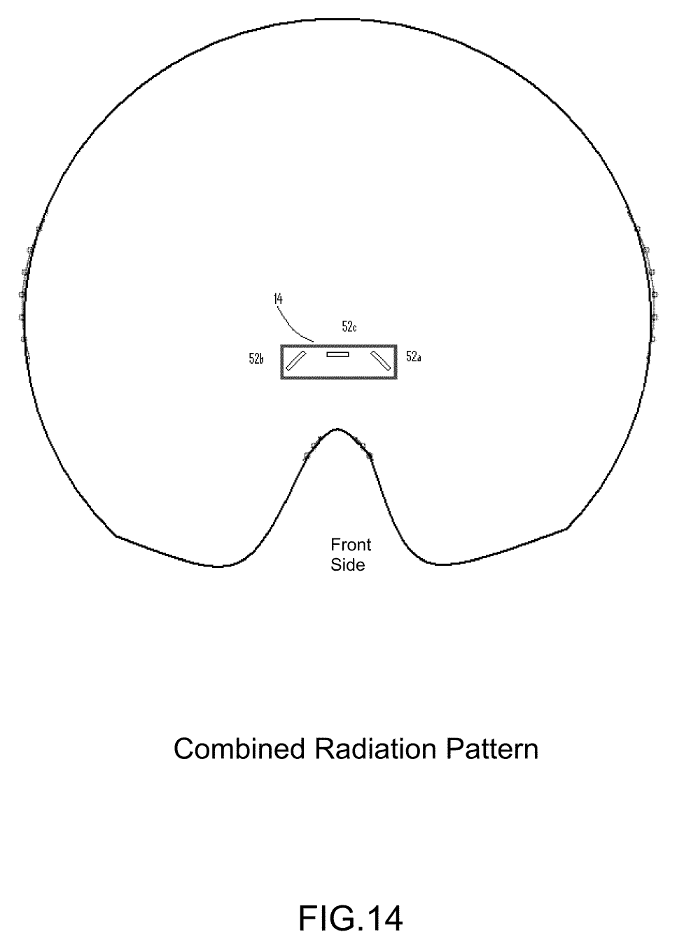

The handheld wireless digital device 50 of FIGS. 12-13 is similar to the device 10 of FIG. 1. The handheld wireless device 50 includes three internal antennas 52a, 52b and 52c. The antennas 52a and 52b are similar or the same as the antennas 12a and 12b of FIG. 1. Three planar antennas 52a, 52b and 52c are arranged such that two are in locations substantially similar to the antennas 12a and 12b of FIG. 1, while the antenna 52c is located at the rear of the housing 54 of the handheld wireless digital device 50. The antennas 52a and 52b are angled slightly toward the front of the handheld wireless device, such that their radiation patterns cover azimuthal sectors extending outwards to the sides and partially toward the front of the unit; the antenna 52c covers the azimuthal sector directly behind the unit. FIG. 14 illustrates an example of a combined radiation pattern for the antennas 52a-52c.

The antennas 52a-53c may be multi-band antennas capable of transceiving electromagnetic signals in a plurality of passbands while rejecting electromagnetic signals whose frequencies do not fall within the desired passband of the antennas.

Any of the above preferred embodiments may be applied to wireless digital devices intended for usage in harsh usage environments, including those rated for multiple drops to hard surfaces. For example, wireless digital devices with external antenna(s), when dropped intentionally or accidentally, may suffer breakage of the external antenna(s), which is (are) typically a weak point on the device. This may invariably lead to degradation or permanent discontinuation of the wireless communication link. The systems 10 and 50 offer numerous advantages to the user, having antennas mounted internally within the digital device and mitigate against degradation or discontinuation of the wireless communication link due to harsh treatment of the external device housing.

One or more currently preferred embodiments have been described by way of example. It will be apparent to persons skilled in the art that a number of variations and modifications can be made without departing from the scope of the invention as defined in the claims.

What is claimed is:

1. An antenna system, comprising:
an array of N antennas (N: integer), each covering an angular sector in space approximately equal to 2*π/N radians in azimuth; and
a mounting structure for arranging the array of N antennas in a wireless digital device to provide a pseudo-omnidirectional electromagnetic spatial coverage such that the total azimuthal coverage toward the exterior of the wireless digital device is substantially spherical except the direction of a user using the wireless digital device, and the combined antenna radiation pattern exhibits a strong null in the direction of the user.

2. An antenna system as claimed in claim 1, wherein the mounting structure mounts the antennas in the wireless digital device such that combined electromagnetic radiation to the user and the absorption (SAR) thereof by the user is minimized.

3. An antenna system as claimed in claim 2, wherein the antenna comprises:
a source plane having a source slot; and
a ground plane having a ground slot,
the antenna being positioned in the wireless digital device such that the ground plane faces the user when using the wireless digital device.

4. An antenna system as claimed in claim 1, wherein the wireless digital device comprises one or more electromagnetically reflective assemblies, and wherein the mounting structure mounts the antennas in the wireless digital device with respect to the one or more electromagnetically reflective assemblies such that the combined antenna radiation pattern is modified by the presence of the one or more electromagnetically reflective assemblies and exhibits a strong null in the direction of the user of the wireless digital device.

5. An antenna system as claim 1, wherein the radiation patterns of the antennas exhibit positive gain in a first direction and negative gain in a second direction opposite to the first direction such that an undesirable electromagnetic signal from the inside of the wireless digital device is rejected, while a desired signal from the outside of the wireless digital device is enhanced.

6. An antenna system as claimed in claim 1, wherein the antennas possess frequency-dependent characteristics such that the antennas reject electromagnetic signals whose frequencies do not fall within the desired passband of the antennas.

7. An antenna system as claimed in claim 6, wherein the antennas are multi-band antennas capable of transceiving electromagnetic signals in a plurality of passbands while rejecting electromagnetic signals whose frequencies do not fall within the desired passband of the antennas.

8. An antenna system as claimed in claim 1, wherein the antenna system exhibits high receiving efficiency in substantially all azimuthal directions except a sector blocked or occupied by presence of the user using the wireless digital device.

9. An antenna system as claimed in claim 4, wherein the one or more electromagnetically reflective assemblies include a main electronic assembly, a mechanical frame assembly, a display assembly or combinations thereof.

10. An antenna system as claimed in claim 9, wherein two or more antennas of the N antennas are coupled directly to radio receiving apparatus within the wireless digital device, the receiving apparatus having functionality of selecting the strongest received signal from any one of the antennas.

11. An antenna system as claimed in claim 10, wherein at least one of the antennas is used for the transmission of digital data to a wireless communication network infrastructure.

12. An antenna system as claimed in claim 11, wherein the wireless digital device is a rugged or semi-rugged device.
